(19) United States
(12) Patent Application Publication
(10) Pub. No.: US 2011/0155069 A1
(43) Pub. Date: Jun. 30, 2011

(54) HAMMOCK FOR A CAT OR OTHER DOMESTIC ANIMAL

(76) Inventor: Timothy Edmonds, Asheville, NC (US)

(21) Appl. No.: 12/648,732

(22) Filed: Dec. 29, 2009

(51) Int. Cl. A01K 1/035; A01K 29/00; A47C 19/12

(52) U.S. Cl. 119/28.5; 5/110

(57) ABSTRACT

A hammock for a pet such as a cat is provided and includes a pair of scissor legs, a second pair of scissor legs, and a pair of rails, each rail extending between, and connected to, a leg of the one pair of the scissor legs and to a leg on the other pair of scissor legs. The hammock also includes a textile sheet, the textile sheet being supported by the pairs of scissor legs, whereupon the hammock is foldable in a fold-up movement that brings the sides of the textile sheet toward one another and thereby collapses the textile sheet and unfoldable in a spread apart movement that spreads the sides of the textile sheet apart from another. The hammock further includes a rod and spoke assembly interconnecting the pair of rails to one another and operating to resist a fold-up movement of the hammock.

### BACKGROUND OF THE INVENTION

This invention relates to an article such as a hammock that can support a cat or other domestic animal at a comfortable height above a residential home floor.

U.S. Pat. No. 5,860,389 to Caldwell notes the desirability of pet beds having an aesthetically pleasing base and a detachable, washable sleeping surface. According to U.S. Pat. No. 5,860,389 to Caldwell, animals by nature like to sleep in an environment of warmth and security and cats, in particular, like to sleep on an elevated surface—i.e. a surface that does not rest directly on the floor. U.S. Pat. No. 5,860,389 to Caldwell notes that one device has been provided which includes a wood frame which supports a fabric rest surface in an elevated position. Another device is a bunk bed style hammock which includes a plastic frame supporting one or more fabric rest surfaces in a stacked elevated position.

U.S. Pat. No. 6,338,314 to Widrich shows a bed for receiving domestic animals. The bed comprises a support means having a substantially peripheral frame. A first web of flexible material is securely attached at each of its opposed ends to the frame so as to span thereacross and present an animal receiving surface. A second web of flexible material is securely attached at each of its opposed ends to the frame so as to span thereacross, and is oriented substantially transversely to the first web of flexible material in supporting relation to the first piece of flexible material. According to U.S. Pat. No. 6,338,314 to Widrich, there are many different types of designs for beds for domestic animals, specifically pets. The most common type is a basket or shallow box-like structure that rests on a floor and presents an animal receiving surface, typically in the form of a pillow, that is marginally above floor level. Problems with such basket or shallow box-like pet beds include the fact that they keep the pet close to a floor that may be quite cold, and where cold drafts may be present. Further, molding and rotting of such basket or shallow box-like pet beds is quite likely to occur due to the temperature difference between the floor and the animal's body. More sophisticated beds for pets comprise a frame made either from wood or metal, with a fabric web of material that is supported by the frame so as to raise the pet a few inches or so off the floor.

It can therefore be seen that there is a need for an arrangement that can support a cat or other domestic animal at a comfortable height above a residential home floor. Moreover, it would be advantageous if such an arrangement is aesthetically pleasing so that, in addition to being functional, it can be placed in a residence and appear to fit in with home furnishings and other surroundings. It is also desirable that the textile repose surface on which the cat can repose is washable and easily removable and replaceable.

Therefore, what is needed is a pet bed which has an elevated rest surface formed of a supportive yet comfortable fabric. The rest surface should ideally be washable and easily detachable from the support frame. The bed also should be aesthetically pleasing so as to fit in with home furnishings and other domestic surroundings.

### SUMMARY OF THE INVENTION

It is an object of the present invention to provide a hammock for a cat or other domestic animal, wherein the domestic animal is raised off the floor.

It is another object of the present invention to provide a hammock for a cat or other domestic animal, with the hammock having a frame and a textile sheet.

It is yet another object of the present invention to provide a hammock for a cat or other domestic animal, which hammock is more comfortable than prior art hammocks.

According to one aspect of the present invention, there is provided a hammock for a pet. The hammock includes a pair of scissor legs, another pair of scissor legs, and a pair of rails. Each rail extends between and is connected to a leg of one pair of the scissor legs and to a leg on the other pair of scissor legs. The hammock also includes a textile sheet. The textile sheet is supported by the pairs of scissor legs. The pairs of scissor legs, the pair of rails, and the textile sheet together are foldable in a fold-up movement that brings the sides of the textile sheet toward one another and thereby collapses the textile sheet and are unfoldable in a spread apart movement that spreads the sides of the textile sheet apart from another. The hammock also includes a rod and spoke assembly. The rod and spoke assembly interconnects the pair of rails to one another and operates to resist a fold-up movement of the hammock.

According to a feature of the one aspect of the present invention, the textile sheet of the hammock includes pocket-shaped end portions each for receipt of a top portion of the legs of a respective one of the pair of legs.

According to another feature of the one aspect of the present invention, the rod and spoke assembly of the hammock includes a left spoke. The left spoke has a home end which is operatively connected to the distal end of the left leg. The left spoke also has a far end. Each of the far end of the left spoke and the far end of the right spoke includes a throughbore through which the rod extends such that the left spoke and the right spoke are rotatably coupled to the rod in a manner in which the left spoke and the right spoke each can rotate relative to the rod.

According to another aspect of the present invention, there is provided an article which includes a first pair of legs. The first pair of legs includes a left leg and a right leg and each leg has a proximate end and a distal end. The distal end is spaced from its proximate end relative to a riser axis. The article also includes a first leg joint. The first leg joint interconnects the first pair of legs to one another at a joint location intermediate the proximate and distal ends of the legs. The first leg joint interconnects the first pair of legs to one another such that the legs are movable in a scissor-like manner in which a fold-up movement to move the distal ends of the legs toward one another relative to a spread axis perpendicular to the riser axis effects movement of the proximate ends of the legs toward one another and a spread-apart movement to move the distal ends of the legs away from one another relative to the spread axis effects movement of the proximate ends of the legs away from one another. The article also includes a complementary leg portion. The complementary leg portion is spaced from the first pair of legs relative to a bi-sector axis perpendicular to the riser axis and the spread axis. The article also includes a supported extent. The supported extent extends between the first pair of legs and the complementary leg portion and has one end supported by the complementary leg portion and another end supported by a respective one of the proximate ends of the left and right legs or the distal ends of the left and right legs. The article also includes a left spoke. The left spoke has a home end operatively connected to the distal end of the left leg and has a far end. The article also includes a right spoke. The right spoke has a home end operatively connected to the distal end of the right leg and has a far end. The article also includes a counterpose connector. The counterpose connector is operable to interconnect the far ends of the left spoke and the right spoke to one another at least at a time when a force is exerted on the first pair of legs to effect a fold-up movement of the legs and the counterpose connector interconnecting the far ends of the left spoke and the right spoke such that a force exerted by the far end of the left spoke along one direction relative to the spread axis is opposed by a force exerted by the far end of the right spoke along an opposite direction relative to the spread axis in a manner that prevents the distal ends of the first pair of legs from moving toward one another.

According to a feature of the another aspect of the present invention, the first pair of legs of the article includes a pair of scissor legs.

According to another feature of the another aspect of the present invention, the complementary leg portion of the article includes a second pair of scissor legs.

According to yet another feature of the another aspect of the present invention, the article includes a pair of rails, each rail extending between, and connected to, a leg of the one pair of the scissor legs and to a leg on the other pair of scissor legs.

According to still yet another feature of the another aspect of the present invention, the supported extent of the article is a textile sheet. The textile sheet is supported by the pairs of scissor legs. The pairs of scissor legs, the pair of rails, and the textile sheet together are foldable in a fold-up movement that brings the sides of the textile sheet toward one another and thereby collapses the textile sheet and are unfoldable in a spread apart movement that spreads the sides of the textile sheet apart from another.

According to another further feature of the another aspect of the present invention, the counterpose connector of the article includes a rod and spoke assembly. The rod and spoke assembly interconnects the pair of rails to one another and operates to resist a fold-up movement of the hammock.

According to an additional feature of the another aspect of the present invention, the counterpose connector of the article includes a biasing spring and a frictional engagement arrangement. Each of the far end of the left spoke and the far end of the right spoke includes a throughbore through which the rod extends such that the left spoke and the right spoke are rotatably coupled to the rod in a manner in which the left spoke and the right spoke each can rotate relative to the rod. The biasing spring engages the left spoke and the right spoke and urges each spoke to rotate about the rod in a manner such that the left spoke and the right spoke rotate to move the distal ends of the first pair of legs toward one another. The frictional engagement arrangement includes an enlarged diameter portion on the rod and a reduced diameter portion on the throughbore of the left spoke. The enlarged diameter portion of the rod frictionally engages the reduced diameter portion of the left spoke in a spread apart disposition of the distal ends of the first pair of legs and the enlarged diameter portion of the rod and the reduced diameter portion of the left spoke, in a folded-up disposition of the article, having a reduced frictional engagement with one another than in the spread apart disposition. The biasing spring has a biasing force insufficient to overcome the frictional engagement of the enlarged diameter portion of the rod and the reduced diameter portion of the left spoke in the spread apart disposition yet sufficient to overcome the frictional engagement of the enlarged diameter portion of the rod and the reduced diameter portion of the left spoke in the folded up disposition.

### BRIEF DESCRIPTION OF THE DRAWINGS

An embodiment of the present invention is now described with reference to the following figures of the drawings:

FIG. 1 is a perspective view in partial section of one embodiment of the hammock of the present invention;

FIG. 2 is a perspective view of an embodiment of an article of the present invention in the form of a hammock;

FIG. 3 is a side elevational schematic view of the hammock illustrated in FIG. 2;

FIG. 4 is a side elevational view of the hammock illustrated in FIG. 2 and showing the hammock in a partially folded up disposition;

FIG. 5 is a side elevational schematic view of the hammock illustrated in FIG. 2 and showing the hammock in its fully spread-apart disposition;

FIG. 6 is an enlarged sectional view of the left spoke and the rod of the counterpose connector of the hammock illustrated in FIG. 2; and

FIG. 7 is an enlarged sectional view of the left spoke and the rod illustrated in FIG. 6 in the fully spread-apart disposition of the hammock.

### DETAILED DESCRIPTION OF AN EMBODIMENT

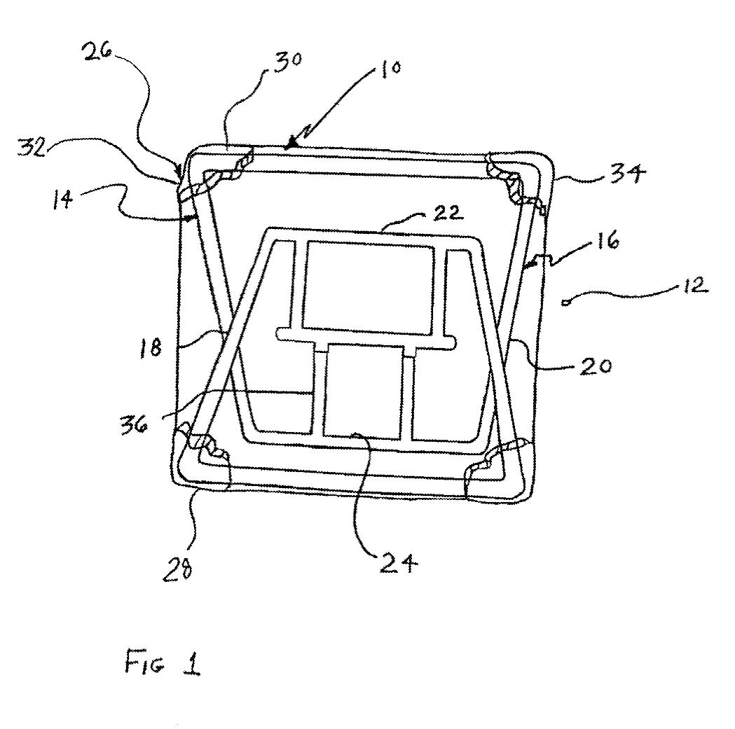

With reference now to FIG. 1, one embodiment of a hammock for a pet is illustrated and is generally designated as a hammock 10. The hammock 10 is particularly suited for supporting a pet such as a domestic cat at a comfortable level above a floor 12 of a residence. The hammock 10 includes a pair of scissor legs 14 and another pair of scissor legs 16. Each respective pair of scissor legs 14 and scissor legs 16 is comprised of two legs that are pivotally connected to each other via a pivot pin 18, 20, respectively, at a location generally at the mid-longitudinal extent of the legs. The hammock 10 also includes a pair of rails 22, 24, each rail extending between, and connected to, a leg of the one pair of the scissor legs 14 and to a leg on the other pair of scissor legs 16. A textile sheet 26 is provided for supporting a pet thereon and the textile sheet 26 is supported by the pairs of scissor legs 14, 16. The textile sheet 26 includes a pair of longitudinal sides 28, 30 and a pair of opposed ends 32, 34. The opposed end 32 of the textile sheet 26 is formed as a pocket that receives therein the inserted tops of the legs of the pair of scissor legs 14. The opposed end 34 of the textile sheet 26 is formed as a pocket that receives therein the inserted tops of the legs of the pair of scissor legs 16. With the legs of the pairs of scissor legs 14, 16 thus received in the pocket-shaped opposed ends 32, 34 of the textile sheet 26, the textile sheet 26 is supported at a predetermined level such as, for example, at a level of a window sill of a residence, such that a domestic cat 36 can be comfortably reposed on the top of the textile sheet.

The pairs of scissor legs 14, 16, the pair of rails 22, 24, and the textile sheet 26 together are foldable in a fold-up movement that brings the longitudinal sides 28, 30 of the textile sheet 26 toward one another and thereby collapses the textile sheet 26 and are unfoldable in a spread apart movement that spreads the longitudinal sides 28, 30 of the textile sheet 26 apart from another. A rod and spoke assembly 36 interconnects the pair of rails 22, 24 to one another and operates to resist a fold-up movement of the hammock 10.

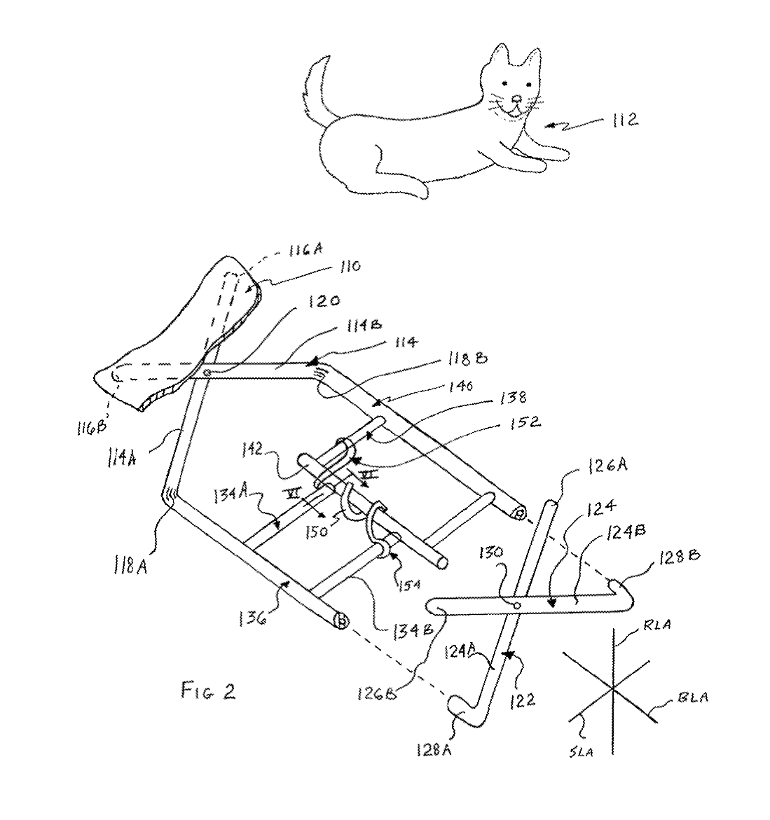

As seen in FIG. 2, an embodiment of an article is illustrated and is shown merely for exemplary purposes as an article in the configuration of a hammock 110 for a pet such as a domestic cat 112. As seen in FIG. 2, which is a perspective view in partial cutaway section, the hammock 110 includes a first pair of legs 114, the first pair of legs 114 including a left leg 114A and a right leg 1148. Each leg 114A, 114B has a proximate end 116A, 116B, respectively, and a distal end 118A, 118B, respectively, spaced from its proximate end relative to a riser axis RLA. A first leg joint 120 interconnects the first pair of legs 114 to one another at a joint location intermediate the proximate and distal ends of the legs 114A, 114B. The first leg joint 120, which may be, for example, in the form of a pair of throughbores, each formed in one of the legs 114A, 1148 and a bolt extending through the throughbores, interconnects the first pair of legs 114 to one another such that the legs 114A, 114B are movable in a scissor-like manner in which a fold-up movement to move the distal ends 118A, 1188 of the legs 114A, 114B toward one another relative to a spread axis SLA perpendicular to the riser axis RLA effects movement of the proximate ends 116A, 1168 of the legs 114A, 1148 toward one another and a spread-apart movement to move the distal ends 118A, 118B of the legs 114A, 1148 away from one another relative to the spread axis SLA effects movement of the proximate ends 116A, 1168 of the legs 114A, 1148 away from one another.

The hammock 110 includes a complementary leg portion 122 which is preferably in the form of second pair of legs 124, the second pair of legs 124 including a left leg 124A and a right leg 124B. Each leg 124A, 124B has a proximate end 126A, 126B, respectively, and a distal end 128A, 128B, respectively, spaced from its proximate end relative to the riser axis RLA. A second leg joint 130 interconnects the second pair of legs 124 to one another at a joint location intermediate the proximate and distal ends of the legs 124A, 124B. The second leg joint 130, which may be, for example, in the form of a pair of throughbores, each formed in one of the legs 124A, 124B and a bolt extending through the throughbores, interconnects the second pair of legs 124 to one another such that the legs 124A, 124B are movable in a scissor-like manner. The complementary leg portion 122 is spaced from the first pair of legs 114 relative to a bi-sector axis BLA perpendicular to the riser axis RLA and the spread axis SLA.

The hammock 110 further includes a supported extent 132 which is preferably in the form of a textile sheet. The supported extent 132 extends between the first pair of legs 114 and the complementary leg portion 122 and has one end supported by the complementary leg portion 122 and another end supported by a respective one of the proximate ends of the left and right legs or the distal ends of the left leg 124A and the right leg 124B. A pair of left spokes 134A, 134B each has a home end operatively connected to the distal end 118A of the left leg 114A of the first pair of legs 114 and has a far end operatively connected to the distal end 128A of the left leg 124A of the second pair of legs 124, these operative connections of the left spokes 134A, 134B being effected by a left rail 136 preferably in the form of a tube extending between, and connected to, the left leg 114A of the first pair of legs 114 and the left leg 124A of the second pair of legs 124. A right spoke 138 has a home end operatively connected to the distal end 118B of the right leg 114B of the first pair of legs 114 and has a far end operatively connected to the distal end 128B of the right leg 124B of the second pair of legs 124, these operative connections being effected by a right rail 140 preferably in the form of a tube extending between, and connected to, the right leg 114B of the first pair of legs 114 and the right leg 124B of the second pair of legs 124.

The hammock 110 includes a counterpose connector having a rod 142 operable to interconnect the far ends of the left spokes 134A, 134B and the right spoke 138 to one another at least at a time when a force is exerted on the first pair of legs 114 to effect a fold-up movement of the first pair of legs 114 and the second pair of legs 124 with the rod 142 interconnecting the far ends of the left spokes 134A, 1348 and the right spoke 138 such that a force exerted by the far ends of the left spokes 134A, 1348 along one direction relative to the spread axis SLA is opposed by a force exerted by the far end of the right spoke 138 along an opposite direction relative to the spread axis SLA in a manner that prevents the distal end 118A of the left leg 114A and the distal end 1188 of the right leg 1248 of the first pair of legs 114 from moving toward one another.

The first pair of legs 114 and the second pair of legs 124 are dimensioned relative to the left spokes 134A, 134B, the right spoke 138, and the rod 142 such that the rod 142 is located approximately mid-way between the distal end 118A of the left leg 114A and the distal end 1188 of the right leg 1248 of the first pair of legs 114 as viewed relative to the spread axis SLA in the fully spread disposition of the hammock 110. Additionally, the first pair of legs 114 and the second pair of legs 124 are dimensioned relative to the left spokes 134A, 134B, the right spoke 138, and the rod 142 such that, when the hammock 110 has been disposed in its folded-up disposition, the rod 142 has been raised to approximately one-half the height of the first pair of legs 114 and the second pair of legs 124, with the referenced height of the first pair of legs 114 and the second pair of legs 124 being the height of the first pair of legs 114 and the second pair of legs 124 in the fully folded disposition of these legs.

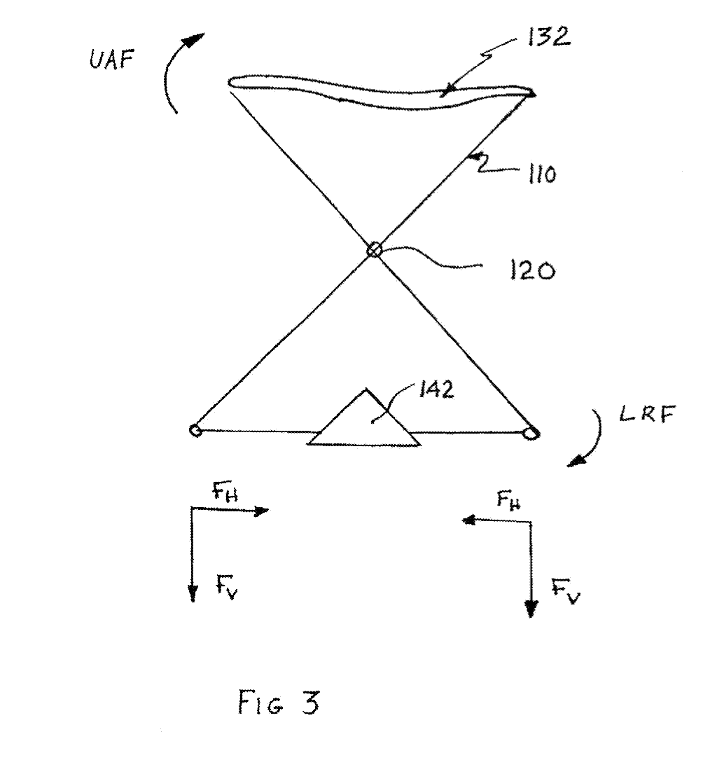

Reference is now had to FIGS. 3-5, wherein the fold-up movement of the hammock 110 and the spread-apart movements of the hammock 110 are illustrated. The left spokes 134A, 134B and the right spoke 138 are in generally horizontal dispositions when the hammock 110 is in its deployed condition. As seen in FIG. 3, which is a schematic side elevational view of the hammock 110, if a user desires to fold together the hammock 110, the user may apply a force to the hammock—hereinafter designated an upper applied force UAF—at the proximate end 1168 of the right leg 1148 of the first pair of legs 114. The application of the upper applied force UAF, which is a moment arm applied in a clockwise direction at a distance from the joint 120, results in a lower reaction force LRF applied through the distal end 118B of the right leg 114B which itself is a moment arm applied in a clockwise direction at a distance from the joint 120. By virtue of the right leg 114B pivoting about the joint 120, an application of the upper applied force UAF in a clockwise manner as illustrated results in a clockwise force exerted through the distal end 118B of the right leg 114B and this clockwise force is the lower reaction force LRF.

The lower reaction force LRF includes a vertical component F_{V} and a horizontal component F_{H}. The horizontal force component F_{H} of the lower reaction force LRF is applied by the far end of the right spoke 138 in one direction along the spread axis SLA against the rod 142. However, this horizontal force component F_{H} of the lower reaction force LRF is opposed by a force of equal magnitude directed in the opposite direction relative to the spread axis SLA, by the left-hand spokes 134A, 134B and, as a result, in spite of the application of the upper applied force UAF to the proximate end 116B of the right leg 114B of the first pair of legs 114, the distal end 118A of the left-hand leg 114A cannot move toward the distal end 118B of the right-hand leg 114B. Thus, the supported extent 132 continues to remain in its deployed condition on the tops of the first pair of legs 114 and the second pair of legs 124.

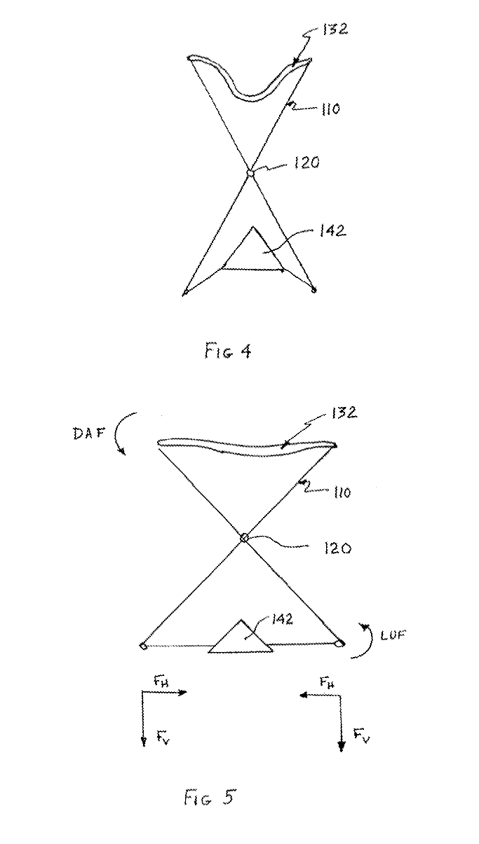

With reference now to FIG. 4, which is a side elevational schematic view of the hammock 110, the hammock is shown during a fold-up movement. To initiate the fold-up movement, a user grasps the rod 142 and lifts the rod upwardly along the riser access RLA. As the rod 142 is raised, the distal ends 118A, 118B of the left-hand leg 114 and the right-hand leg 114B, respectively, are moved toward one another by virtue of the interconnection of these distal ends via the left spokes 134A, 134B and the right spoke 138. By virtue of the fact that the far ends of the left spokes 134A, 134B no longer exert a force in opposition to a force applied by the far end of the right spoke !38, the counterpose connector of the hammock 110 no longer opposes a fold-up movement and the user is able to raise the rod 142 until the first pair of legs 114 and the second pair of legs 124 have each reached its respective fully folded disposition. In the fully folded dispositions of the first pair of legs 114 and the second pair of legs 124, the supported extent 132 collapses inwardly and downwardly and the hammock 110 is now in a ready disposition to be placed, for example, in storage in a closet or carried to a different location.

With reference to FIG. 5, a spread-apart movement of the hammock 110 is illustrated. A downward-applied force DAF is applied, for example, to the proximate end 1168 of the right leg 1148 of the first pair of legs 114 and this downward-applied force DAF results in a lower unfolding force LUF being applied through the distal end 1188 of the right leg 1148. The lower unfolding force LUF effects downward movement of the left spokes 134A, 1348 and the right spoke 138 until these spokes are in generally horizontal dispositions, at which point further spreading movement of the distal ends 118A, 1188 is no longer possible. In the fully spread apart disposition of the hammock 110, the supported extent 132 is supported at the tops of the first pair of legs 114 and the second pair of legs 124 in a spread apart but not taut disposition.

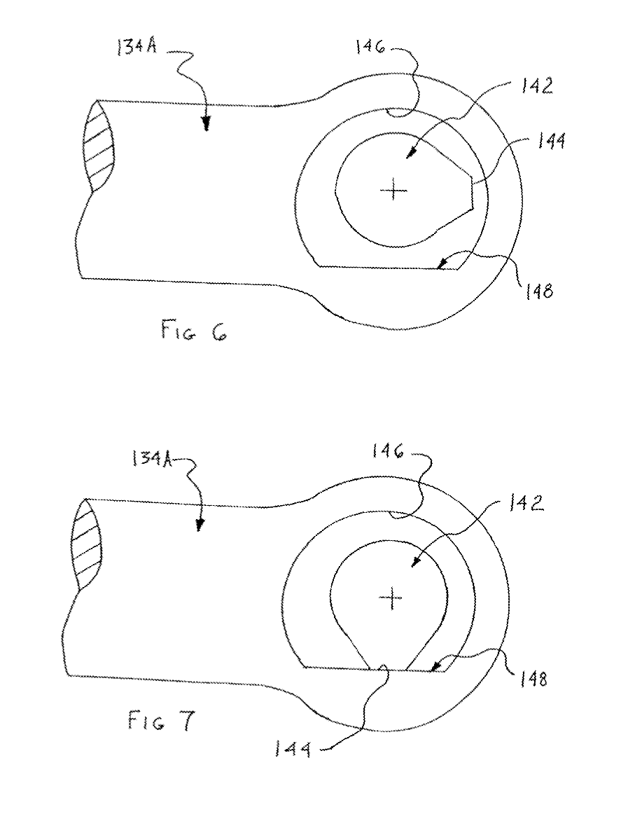

Reference is now had to FIG. 6, which is an enlarged sectional view of the left-hand spoke 134A and the rod 142 taken along the lines VI-VI in FIG. 2. The rod 142 has a cross section perpendicular to its longitudinal axis having a circumference a portion of which is at a constant diameter and the remaining portion of the circumference, designated the enlarged diameter circumference portion 144, is at a larger radius from the longitudinal center line of the rod 142 than its constant diameter portion. The left spoke 134A includes a throughbore 146 through which the rod 142 extends and the throughbore 146 is formed with a constant diameter portion along a portion of its circumference and has a reduced diameter portion 148 along the remainder of its circumference, this reduced diameter portion 148 being at a lesser radius from a center line of the throughbore 146 than the constant diameter portion of the throughbore. As seen in FIG. 6, which illustrates a position of the left spoke 134A and the rod 142 at the time illustrated in FIG. 4 in which the hammock 110 is in the process of being folded up, the enlarged diameter circumference portion 144 of the rod 142 is out of contact with the reduced diameter circumference portion 148 of the throughbore 146 of the left spoke 134A. As now seen in FIG. 7, which illustrates a time at which the left spoke 134A has assumed its generally horizontal disposition in the fully spread-apart disposition of the hammock 110, the enlarged diameter circumferential portion 144 of the rod 142 is now in frictional contact with the reduced diameter circumferential portion 148 of the throughbore 146 of the left spoke 134A and this frictional contact operates to resist a counter-clockwise rotation of the left spoke 134A relatively about the rod 142.

As seen in FIG. 2, the hammock 110 includes a biasing spring 150 having one end extending over the top of the right spoke 138 and an opposite end 154 extending over the left spoke 1348. The biasing spring 150 biases the left spokes 134A, 134B and the right spoke 138 toward their generally horizontal dispositions in the fully spread-apart disposition of the hammock 110. The biasing force of the biasing spring 150 is configured in correspondence with the frictional engagement between the enlarged diameter circumferential portion 144 of the rod 142 and the reduced diameter portion 148 of the throughbore 146 of the left spoke 134A such that the biasing spring 150 cannot, alone, overcome this frictional engagement. However, once a user initiates an upward movement of the rod 142 by raising the rod, such as is illustrated in connection with FIG. 4, the rod 142 is eventually raised to an extent that the left spoke 134A rotates clockwise relative to the rod sufficiently to bring the reduced diameter circumferential extent 148 of the throughbore 146 out of frictional engagement with the enlarged diameter circumferential extent 144 of the rod 142 and, at that point, the biasing action of the biasing spring 150 urges the left-hand spokes 134A, 134B and the right-hand spoke 138 to assume their folded up dispositions.

The article of the present invention has been exemplarily disclosed and illustrated with respect to a hammock for a cat or other domestic animal but it is to be understood that the article can as well be any structure in which it is desirable or advantageous to have a supported extent on which an animal can repose. For example, the article could be of a structure comprising several pairs of folding legs and deployed in a circumstance in which it is desirable to adjustably position the legs at varying heights.

From the foregoing description of one embodiment of the invention, it will be apparent that many modifications may be made therein. It will be understood that this embodiment of the invention is an exemplification of the invention only and that the invention is not limited thereto.

1-3. (canceled)

4. An article comprising:
a first pair of legs, the first pair of legs including a left leg and a right leg and each leg having a proximate end and a distal end spaced from its proximate end relative to a riser axis;
a first leg joint, the first leg joint interconnecting the first pair of legs to one another at a joint location intermediate the proximate and distal ends of the legs, the first leg joint interconnecting the first pair of legs to one another such that the legs are movable in a scissor-like manner in which a fold-up movement to move the distal ends of the legs toward one another relative to a spread axis perpendicular to the riser axis effects movement of the proximate ends of the legs toward one another and a spread-apart movement to move the distal ends of the legs away from one another relative to the spread axis effects movement of the proximate ends of the legs away from one another;
a complementary leg portion, the complementary leg portion being spaced from the first pair of legs relative to a bi-sector axis perpendicular to the riser axis and the spread axis;
a supported extent, the supported extent extending between the first pair of legs and the complementary leg portion and having one end supported by the complementary leg portion and another end supported by a respective one of the proximate ends of the left and right legs or the distal ends of the left and right legs;
a left spoke, the left spoke having a home end operatively connected to the distal end of the left leg and having a far end;
a right spoke, the right spoke having a home end operatively connected to the distal end of the right leg and having a far end; and
a counterpose connector, the counterpose connector being operable to interconnect the far ends of the left spoke and the right spoke to one another at least at a time when a force is exerted on the first pair of legs to effect a fold-up movement of the legs and the counterpose connector interconnecting the far ends of the left spoke and the right spoke such that a force exerted by the far end of the left spoke along one direction relative to the spread axis is opposed by a force exerted by the far end of the right spoke along an opposite direction relative to the spread axis in a manner that prevents the distal ends of the first pair of legs from moving toward one another, wherein the first pair of legs includes a pair of scissor legs and the complementary leg portion includes a second pair of scissor legs, and the article further comprising a pair of rails, each rail extending between, and connected to, a leg of the one pair of the scissor legs and to a leg on the other pair of scissor legs, wherein the supported extent is a textile sheet, the textile sheet being supported by the pairs of scissor legs, whereupon the pairs of scissor legs, the pair of rails, and the textile sheet together are foldable in a fold-up movement that brings the sides of the textile sheet toward one another and thereby collapses the textile sheet and being unfoldable in a spread apart movement that spreads the sides of the textile sheet apart from another, the counterpose connector includes a rod and spoke assembly, the rod and spoke assembly interconnecting the pair of rails to one another and operating to resist a fold-up movement of the hammock, and the counterpose connector includes a biasing spring and a frictional engagement arrangement, each of the far end of the left spoke and the far end of the right spoke includes a throughbore through which the rod extends such that the left spoke and the right spoke are rotatably coupled to the rod in a manner in which the left spoke and the right spoke each can rotate relative to the rod, the biasing spring engages the left spoke and the right spoke and urges each spoke to rotate about the rod in a manner such that the left spoke and the right spoke rotate to move the distal ends of the first pair of legs toward one another, and the frictional engagement arrangement includes an enlarged diameter portion on the rod and a reduced diameter portion on the throughbore of the left spoke, the enlarged diameter portion of the rod frictionally engaging the reduced diameter portion of the left spoke in a spread apart disposition of the distal ends of the first pair of legs and the enlarged diameter portion of the rod and the reduced diameter portion of the left spoke, in a folded-up disposition of the article, having a reduced frictional engagement with one another than in the spread apart disposition, the biasing spring having a biasing force insufficient to overcome the frictional engagement of the enlarged diameter portion of the rod and the reduced diameter portion of the left spoke in the spread apart disposition yet sufficient to overcome the frictional engagement of the enlarged diameter portion of the rod and the reduced diameter portion of the left spoke in the folded up disposition.

5-10. (canceled)

11. A hammock for a pet; the hammock comprising:
a first pair of legs, the first pair of legs including a left leg and a right leg and each leg having a proximate end and a distal end spaced from its proximate end relative to a riser axis;
a first leg joint, the first leg joint interconnecting the first pair of legs to one another at a joint location intermediate the proximate and distal ends of the legs, the first leg joint interconnecting the first pair of legs to one another such that the legs are movable in a scissor-like manner in which a fold-up movement to move the distal ends of the legs toward one another relative to a spread axis perpendicular to the riser axis effects movement of the proximate ends of the legs toward one another and a spread-apart movement to move the distal ends of the legs away from one another relative to the spread axis effects movement of the proximate ends of the legs away from one another;
a complementary leg portion, the complementary leg portion being spaced from the first pair of legs relative to a bi-sector axis perpendicular to the riser axis and the spread axis;
a supported extent, the supported extent extending between the first pair of legs and the complementary leg portion and having one end supported by the complementary leg portion and another end supported by a respective one of the proximate ends of the left and right legs or the distal ends of the left and right legs;
a left spoke, the left spoke having a home end operatively connected to the distal end of the left leg and having a far end;
a right spoke, the right spoke having a home end operatively connected to the distal end of the right leg and having a far end;
a counterpose connector, the counterpose connector being operable to interconnect the far ends of the left spoke and the right spoke to one another at least at a time when a force is exerted on the first pair of legs to effect a fold-up movement of the legs and the counterpose connector interconnecting the far ends of the left spoke and the right spoke such that a force exerted by the far end of the left spoke along one direction relative to the spread axis is opposed by a force exerted by the far end of the right spoke along an opposite direction relative to the spread axis in a manner that prevents the distal ends of the first pair of legs from moving toward one another, wherein the first pair of legs includes a pair of scissor legs, the complementary leg portion includes a second pair of scissor legs; and
a pair of rails, each rail extending between, and connected to, a leg of the one pair of the scissor legs and to a leg on the other pair of scissor legs, wherein the supported extent is a textile sheet, the textile sheet being supported by the pairs of scissor legs, whereupon the pairs of scissor legs, the pair of rails, and the textile sheet together are foldable in a fold-up movement that brings the sides of the textile sheet toward one another and thereby collapses the textile sheet and being unfoldable in a spread apart movement that spreads the sides of the textile sheet apart from another, the counterpose connector includes a rod and spoke assembly, the rod and spoke assembly interconnecting the pair of rails to one another and operating to resist a fold-up movement of the hammock, and the counterpose connector includes a biasing spring and a frictional engagement arrangement, each of the far end of the left spoke and the far end of the right spoke includes a throughbore through which the rod extends such that the left spoke and the right spoke are rotatably coupled to the rod in a manner in which the left spoke and the right spoke each can rotate relative to the rod, the biasing spring engages the left spoke and the right spoke and urges each spoke to rotate about the rod in a manner such that the left spoke and the right spoke rotate to move the distal ends of the first pair of legs toward one another, and the frictional engagement arrangement includes an enlarged diameter portion on the rod and a reduced diameter portion on the throughbore of the left spoke, the enlarged diameter portion of the rod frictionally engaging the reduced diameter portion of the left spoke in a spread apart disposition of the distal ends of the first pair of legs and the enlarged diameter portion of the rod and the reduced diameter portion of the left spoke, in a folded-up disposition of the article, having a reduced frictional engagement with one another than in the spread apart disposition, the biasing spring having a biasing force insufficient to overcome the frictional engagement of the enlarged diameter portion of the rod and the reduced diameter portion of the left spoke in the spread apart disposition yet sufficient to overcome the frictional engagement of the enlarged diameter portion of the rod and the reduced diameter portion of the left spoke in the folded up disposition.
